(19) United States
(12) Patent Application Publication
(10) Pub. No.: US 2007/0129215 A1
(43) Pub. Date: Jun. 7, 2007

(54) Method and system for controlling an operation of a damper clutch

(76) Inventor: Hyun Joo Kim, Ansan-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/305,734

(22) Filed: Dec. 15, 2005

(30) Foreign Application Priority Data
Dec. 5, 2005 (KR) 10-2005-0117802

(51) Int. Cl. B60W 10/02

(52) U.S. Cl. 477/174

(57) ABSTRACT

The present invention relates to a method and a system for controlling an operation of a damper clutch for reducing a shock that occurs when a damper clutch is directly coupled, and reducing a time to become completely coupled. A method for controlling an operation of a damper clutch according to an exemplary embodiment of the present invention includes determining whether a direct coupling condition of a damper clutch is satisfied, performing an engine torque reduction control for reducing an engine torque when the direct coupling condition is satisfied, performing a damper clutch coupling control such that the damper clutch is directly coupled after the engine torque is reduced, and returning the engine torque to a base state after direct coupling of the damper clutch is completed.

### CROSS-REFERENCE TO RELATED APPLICATION

This application claims priority to and the benefit of Korean Patent Application No. 10-2005-0117802 filed in the Korean Intellectual Property Office on Dec. 05, 2005, the entire contents of which are incorporated herein by reference.

### BACKGROUND OF THE INVENTION

(a) Field of the Invention

The present invention relates to a method and a system for controlling an operation of a damper clutch. More particularly, the present invention relates to a method and a system for controlling an operation of a damper clutch for reducing a shock that occurs when a damper clutch is directly coupled, and reducing a time for complete coupling of the damper clutch.

(b) Description of the Related Art

In a conventional vehicle having a conventional automatic transmission installed therein, a method for gradually increasing a duty ratio before an RPM of an engine and an RPM of a turbine become the same is used to reduce a shock that occurs when a damper clutch is directly coupled is used.

In addition, a method for operating a damper clutch while a fuel supply is cut off by an ECU (engine control unit) during deceleration of a vehicle so as to reduce fuel consumption is used.

However, according to such conventional methods, a significant shock may problematically occur when a damper clutch is operated in a condition where the engine torque is large.

Therefore, to solve the above-mentioned problem of shock occurrence, a method for gradually increasing hydraulic pressure so as to delay a time when direct coupling of the damper clutch is completed is used. According to the method, a time duration (from a time when hydraulic pressure starts to increase to a time when direct coupling of the damper clutch is completed) is increased, and direct coupling of the damper clutch is prohibited in a time duration when the shock occurs.

FIG. 1 shows a relationship of damper clutch hydraulic pressure, engine RPM, and turbine RPM, according to the conventional method for controlling an operation of a damper clutch by controlling hydraulic pressure.

The damper clutch starts to be operated at a first point of time. Therefore, initial hydraulic pressure duty control for controlling a damper clutch is controlled to have a lower hydraulic pressure.

The damper clutch is completely coupled at a second point of time.

During a time duration between the first point of time and the second point of time, the hydraulic pressure for controlling the damper clutch is controlled to gradually increase. At this time, engine RPM decreases as hydraulic pressure duty control for controlling a damper clutch increases.

According to the graph, it takes 3.4 seconds from the starting time to the completed time for direct coupling of the damper clutch.

Due to such a delay time, fuel consumption efficiency problematically becomes worse.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and system for controlling an operation of a vehicle having advantages of reducing a shock that occurs when a damper clutch is directly coupled, and reducing a time for complete coupling of the damper clutch.

A method for controlling an operation of a damper clutch according to an exemplary embodiment of the present invention includes determining whether a direct coupling condition of a damper clutch is satisfied; performing an engine torque reduction control for reducing an engine torque when the direct coupling condition is satisfied; performing a damper clutch direct coupling control such that the damper clutch is directly coupled after the engine torque is reduced; determining whether direct coupling of the damper clutch is completed; and terminating the engine torque reduction control after direct coupling of the damper clutch is completed.

The determining whether a direct coupling condition of the damper clutch is satisfied may be performed on the basis of the engine torque and ignition timing.

The determining whether a direct coupling of the damper clutch is completed may be performed by a TCU (transmission control unit) on the basis of a damper clutch hydraulic pressure. p In addition, a method for controlling an operation of a damper clutch according to an exemplary embodiment of the present invention includes determining whether a direct coupling condition of a damper clutch is satisfied; requesting a reduction of an engine torque reduction to an ECU (engine control unit) when the direct coupling condition of the damper clutch is satisfied; receiving an instruction from the ECU that allows an operation of the damper clutch after the engine torque is reduced; performing a damper clutch direct coupling control; determining whether direct coupling of the damper clutch is completed; and notifying the ECU that the damper clutch is completely coupled.

The determining whether a direct coupling condition of the damper clutch is satisfied may be performed on the basis of the engine torque and ignition timing.

The determining whether a direct coupling of the damper clutch is completed may be performed by a TCU (transmission control unit) on the basis of a damper clutch hydraulic pressure.

A control system for controlling an operation of a damper clutch, according to an exemplary embodiment of the present invention, includes a TCU (transmission control unit) controlling an automatic transmission; and an ECU (engine control unit) for controlling an engine. The TCU is programmed so as to request a reduction of an engine torque to the ECU when a direct coupling condition is determined to be satisfied; to control the damper clutch such that the damper clutch is operated to be coupled when a signal for allowing a direct coupling of the damper clutch is inputted from the ECU; to determine whether the direct coupling of the damper clutch is completed; and to output a signal of a completion of direct coupling of the damper clutch to the ECU. The ECU is programmed to reduce an engine torque on the basis of a request for reducing the engine torque from the TCU; to deliver a signal to the TCU that allows an operation of the damper clutch such that the damper clutch is directly coupled after reducing the engine torque; and to return the engine torque to the initial state on the basis of a signal that the coupling of the damper clutch is completed that is delivered from the TCU.

The ECU may reduce an engine torque by retarding ignition timing.

### BRIEF DESCRIPTION OF THE DRAWINGS

FIG. 1 is a graph showing changes of some values of vehicle conditions when a damper clutch is operated according to a conventional method.

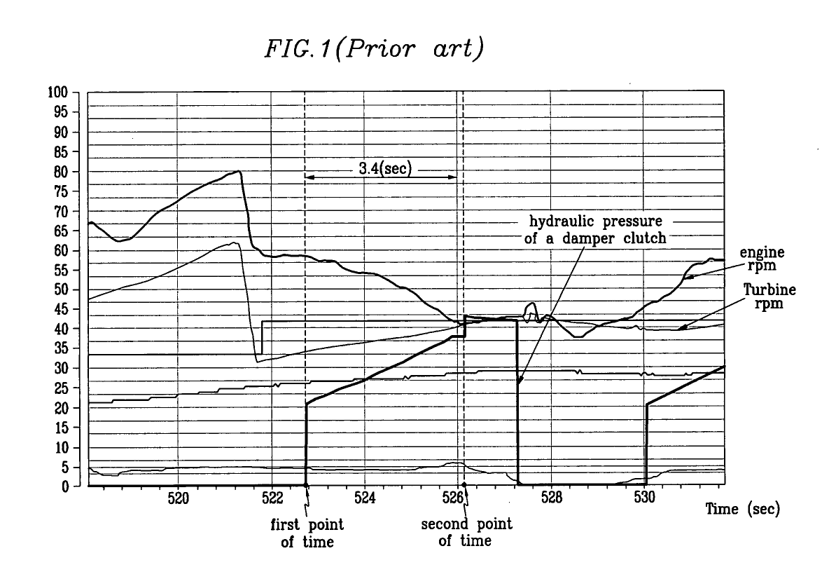

FIG. 2 is a schematic diagram showing information inputted to a TCU and an ECU according to an exemplary embodiment of the present invention.

FIG. 3 is a flowchart of a method for controlling an operation of a damper clutch according to an exemplary embodiment of the present invention.

FIG. 4 is a graph showing changes of some values of vehicle conditions when a damper clutch is operated according to an exemplary embodiment of the present invention.

### DETAILED DESCRIPTION OF THE EMBODIMENTS

An exemplary embodiment of the present invention will hereinafter be described in detail with reference to the accompanying drawings.

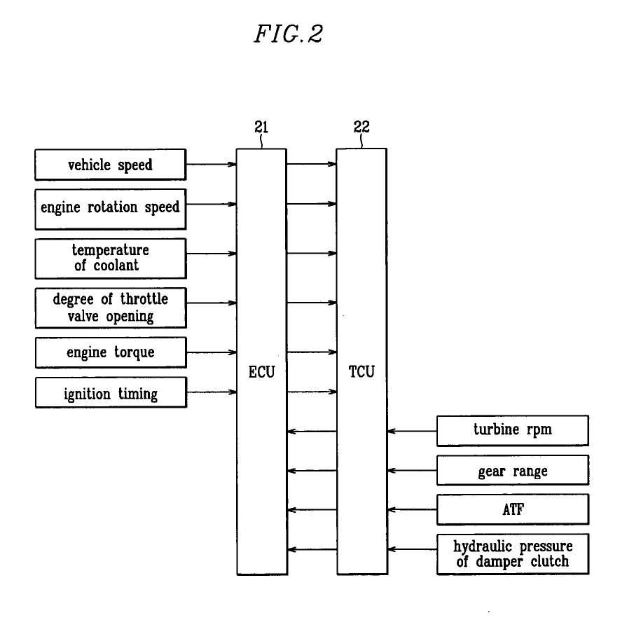

FIG. 2 shows an ECU 21, a TCU 22, and information of vehicle condition inputted to the ECU and TCU. The information is used in a method for controlling an operation of a damper clutch according to an exemplary embodiment of the present invention.

The ECU 21 and TCU 22 include a microprocessor, a memory, and other related hardware and software, and are programmed to perform processes of a method for controlling an operation of a damper clutch according to this exemplary embodiment of the present invention, which will be described.

According to this exemplary embodiment of the present invention, a vehicle speed, an engine speed, a coolant temperature, and a degree of throttle valve opening are inputted to the ECU so as to be commonly used by the ECU and TCU. In addition, an engine torque and ignition timing are further inputted to the ECU.

A turbine RPM, a gear range, and information of automatic transmission fluid (ATF) are inputted to the TCU so as to be commonly used by the TCU and ECU. In addition, a damper clutch hydraulic pressure is further inputted to the TCU.

When the above-mentioned information is inputted to the TCU and the ECU, the TCU and the ECU share the information and perform a control for an operation of a damper clutch and a control of engine torque to control the operation of a damper clutch.

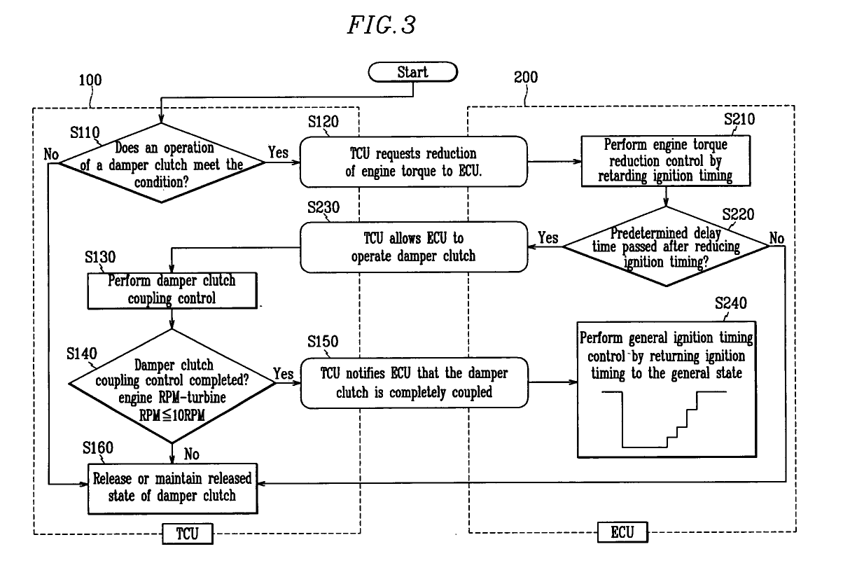

Hereinafter, a method for controlling an operation of the damper clutch according to this exemplary embodiment of the present invention will be described in detail with reference to FIG. 3.

In the FIG. 3, reference numeral 100 indicates an area controlled by the TCU, and a reference numeral 200 indicates an area controlled by the ECU.

Firstly, it is determined whether a direct coupling condition of a damper clutch is satisfied at step S100. In this step, the TCU determines whether a condition for performing an operation of a damper clutch such that the damper clutch is directly coupled is satisfied.

Then, if the direct coupling condition of the damper clutch is satisfied, the TCU requests a reduction of engine torque to an ECU (engine control unit) at step S120.

Then, when the ECU receives a request for reducing the engine torque, the ECU performs an engine torque reduction control. That is, the ECU retards ignition timing so as to reduce the engine torque, at step S210.

Then, the ECU determines whether a predetermined delay time “a” has passed after beginning the retardation of the ignition timing, at step S220.

If the predetermined delay time “a” has passed, the ECU outputs a signal that allows coupling of the damper clutch, to the TCU, at step S320.

When a signal that allows coupling of the damper clutch is delivered to the TCU from the ECU, the TCU performs a damper clutch coupling control such that the damper clutch is directly coupled, in step S130.

Then, the TCU determines whether direct coupling of the damper clutch is completed in step S140. That is, the TCU determines whether the damper clutch is completely coupled.

At this time, if a condition, for example the equation “an engine RPM—a turbine RPM ≦10 RPM”, is satisfied, it is determined that the direct coupling of the damper clutch is completed.

When the damper clutch is determined to be completely coupled, the TCU notifies the ECU that the damper clutch is completely coupled, in step S150.

When the TCU delivers information that the damper clutch is directly and completely coupled, the ECU performs a general ignition timing control based on various control parameters without retarding the ignition for reducing engine torque, at step S240.

At this time, the ignition timing is normalized in stages. If the ignition timing is normalized in one step, a large shock may occur.

On the other hand, in the case that the direct coupling condition of the damper clutch is not satisfied in step S110, the predetermined delay time “a” has not yet passed in step S220, or direct coupling of the damper clutch is not yet completed in step S140, the released state of the damper clutch is maintained or the damper clutch is released, in step S160.

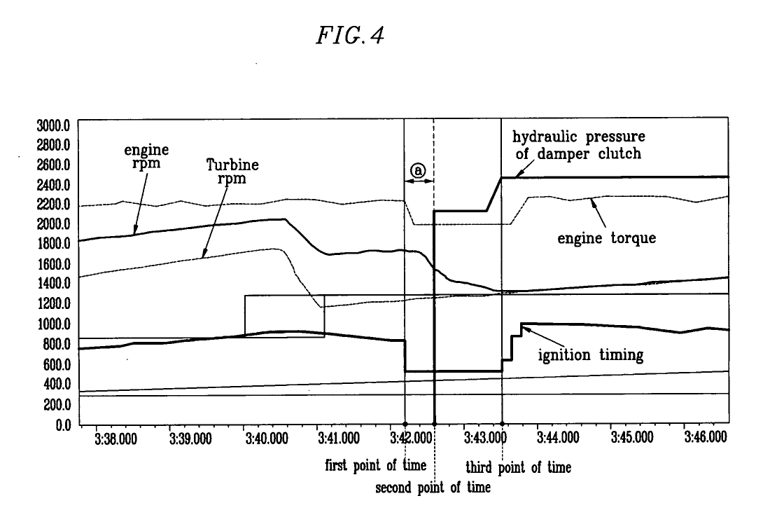

FIG. 4 illustrates changes of some values of vehicle conditions when a damper clutch is operated according to this exemplary embodiment of the present invention.

The engine torque begins to be reduced so as to operate the damper clutch at a first point of time. Since the ignition timing is delayed, the engine torque begins to be reduced at the first point of time.

A second point of time indicates a time when the predetermined delay time “a” has passed after the first point of time indicating a starting time of the engine torque reduction. A hydraulic pressure of the damper clutch increases, and a hydraulic pressure duty control for controlling a damper clutch begins to be performed. That is, the damper clutch coupling control is performed.

The third point of time indicates a time when the direct coupling of the damper clutch is completed. From the third point of time, the delayed ignition timing begins to be returned to the normal state.

Referring to FIG. 4, changes of hydraulic pressure duty control of the damper clutch, engine torque, engine RPM, turbine RPM, and ignition timing, etc., during the operation of the damper clutch according to the exemplary embodiment of the present invention, are easily understood.

According to the exemplary method of the present invention, since the TCU and the ECU share information of the condition of the vehicle, control for operation of the damper clutch and control for reducing the engine torque for control for an operation of the damper clutch can be easily and precisely performed. In addition, an advantageous effect of improving fuel consumption ratio can be achieved.

According to the exemplary method of the present invention, since the damper clutch is directly coupled when the engine torque is reduced, a shock that occurs when the damper clutch is directly coupled can be reduced.

In addition, compared with the conventional method for gradually increasing a hydraulic pressure of the damper clutch, the required time for completing direct coupling of the damper clutch is reduced, and the fuel consumption ratio can be increased.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for controlling an operation of a damper clutch, comprising:
determining whether a direct coupling condition of a damper clutch is satisfied;
performing an engine torque reduction control for reducing an engine torque when the direct coupling condition is satisfied;
performing a damper clutch direct coupling control such that the damper clutch is directly coupled after the engine torque is reduced;
determining whether direct coupling of the damper clutch is completed; and
terminating the engine torque reduction control after a direct coupling of the damper clutch is completed.

2. The method of claim 1, wherein
the determining whether a direct coupling condition of the damper clutch is satisfied is performed on the basis of the engine torque and ignition timing.

3. The method of claim 1, wherein
the determining whether a direct coupling of the damper clutch is completed is performed by a TCU (transmission control unit) on the basis of a damper clutch hydraulic pressure.

4. A method for controlling an operation of a damper clutch, comprising:
determining whether a direct coupling condition of a damper clutch is satisfied;
requesting a reduction of an engine torque to an ECU (engine control unit) when the direct coupling condition of the damper clutch is satisfied;
receiving an instruction that allows an operation of the damper clutch from the ECU after the engine torque is reduced;
performing a damper clutch direct coupling control;
determining whether a direct coupling of the damper clutch is completed; and
notifying the ECU that the damper clutch is completely coupled.

5. The method of claim 4, wherein
the determining whether a direct coupling condition of the damper clutch is satisfied is performed on the basis of the engine torque and ignition timing.

6. The method of claim 4, wherein
the determining whether a direct coupling of the damper clutch is completed is performed by a TCU (transmission control unit) on the basis of a damper clutch hydraulic pressure.

7. A control system for controlling an operation of a damper clutch, comprising:
a TCU (transmission control unit) for controlling an automatic transmission; and
an ECU (engine control unit) for controlling an engine, wherein the TCU is programmed so as to perform
requesting a reduction of an engine torque to the ECU when a direct coupling condition is determined to be satisfied,
controlling the damper clutch such that the damper clutch is operated to be coupled when a signal for allowing a direct coupling of the damper clutch is inputted from the ECU,
determining whether the direct coupling of the damper clutch is completed, and
outputting a signal of a completion of direct coupling of the damper clutch to the ECU, and
the ECU is programmed to perform
reducing an engine torque on the basis of a request for reducing the engine torque from the TCU,
delivering a signal to the TCU that allows an operation of the damper clutch such that the damper clutch is directly coupled after reducing the engine torque, and
returning the engine torque to the initial state on the basis of a signal delivered from the TCU that the coupling of the damper clutch is completed.

8. The system of claim 5, wherein
the ECU reduces an engine torque by retarding ignition timing.
